(19) United States
(12) Patent Application Publication
(10) Pub. No.: US 2002/0067696 A1
(43) Pub. Date: Jun. 6, 2002

(54) Extended quality of service capabilities for WLAN and WPAN applications

(76) Inventor: Jin Meng Ho, Plano, TX (US)

Correspondence Address: Ronald O. Neerings, Texas Instruments Incorporated, M/S 3999, P.O. Box 655474, Dallas, TX, 75265, US

(21) Appl. No.: 09/907,863

(22) Filed: Jul. 18, 2001

Related U.S. Application Data
(60) Provisional application No. 60/250,998, filed on Dec. 4, 2000.

(51) Int. Cl. H04L 12/26

(52) U.S. Cl. 370/235; 370/468

(57) ABSTRACT

A quality of service (QoS) requirement is indicated in a broadband communications station by providing a parameter (52, 53) having a first possible value which indicates that a qualitative QoS requirement is to be implemented for a transport of associated data traffic and having a second possible value which indicates that a quantitative QoS requirement is to be implemented for the transport of the data traffic. The parameter and the data traffic are passed from a first sublayer (LLC) of a data link layer implemented in the broadband communications station to a second sublayer (MAC) of the data link layer. The QoS requirement (55, 56) represented by the parameter is determined based on the value of the parameter, and is then provided to QoS facilities of the broadband communications station.

This application claims the priority under 35 USC 119(e)(1) of copending U.S. provisional application No. 60/250,998 filed on Dec. 4, 2000.

### FIELD OF THE INVENTION

The invention relates generally to broadband communications networks and, more particularly, to quality of service data transport in such networks.

### BACKGROUND OF THE INVENTION

Wireless local area networks (WLAN) as defined by IEEE Std 802.11-1999 (incorporated herein by reference) are capable of providing best effort data transport, but not quality-of-service (QoS) transfer that is needed for multimedia services such as voice, video, and data to meet their requirements on delivery delay, delay jitter, minimum and maximum data rate, and the like. Wireless personal area networks (WPAN) as defined by the Bluetooth 1.0 Specification (incorporated herein by reference) or IEEE Std 802.15.1 (incorporated herein by reference) also do not support QoS for multimedia services.

According to the aforementioned IEEE standards, network traffic flows from the LLC (logical link control) sublayer through a MAC (medium access control) service access point (SAP) on the service interface to the MAC sublayer for transport to a remote station via a broadband channel shared by a plurality of geographically dispersed stations within a WLAN or WPAN. For the MAC sublayer to transmit the network-traffic to its peer or peers in accordance with the corresponding QoS requirements, certain attributes of the network traffic expressed in service primitive parameters are passed from the LLC sublayer down to the MAC sublayer along with the traffic data. These parameters as defined for a conventional IEEE Std 802.11-1999 WLAN are source address, destination address, routing information, priority, and service class. Network traffic is transported by the local MAC sublayer to a peer MAC sublayer in MAC service data units (MSDUs). Each MSDU is sent from the LLC sublayer to the MAC sublayer for such transport via a primitive, referred to in an IEEE Std 802.11-1999 WLAN as MA-UNITDATA.request. The primitive is issued to request a transfer of an MSDU from a local LLC sublayer entity to a single peer LLC sublayer entity, or to multiple peer LLC sublayer entities in the case of group addresses. This primitive also contains the values of the aforementioned service primitive parameters.

For IEEE Std 802.11-1999, the following service primitive parameter values apply. The source address (SA) parameter specifies an individual MAC sublayer address of the MAC sublayer entity to which the MSDU is being transferred (from the LLC sublayer). The destination address (DA) parameter specifies either an individual or a group peer MAC sublayer entity address. The routing information parameter specifies the route desired for the data transfer. If the routing information parameter has a null value, this indicates that source routing is not to be used. The routing information parameter must be null for IEEE 802.11. The data parameter specifies the MSDU that is to be transmitted by the MAC sublayer entity specified by the source address. The priority parameter specifies the priority desired for the MSDU transfer, and is allowed two values that are supported at all stations: Contention and ContentionFree. The service class parameter specifies the service class desired for the MSDU transfer, and is allowed two values: ReorderableMulticast (RM) and StrictlyOrdered (SO).

IEEE Std 802.11E (incorporated herein by reference) is now enhancing its MAC protocol to provide QoS for both realtime and non-realtime applications over the WLAN. In its latest draft, IEEE Std 802.11e/D1 (incorporated herein by reference), it extends the priority parameter to allow the two values already defined for IEEE Std 802.11-1999 stations, Contention and ContentionFree, and eight additional values that are supported only at QoS capable stations: the integers between and including 0 and 7. FIG. 1 illustrates in tabular format the possible values of the priority and service class parameters according to IEEE Standard 802.11e/D1.

The present invention recognizes that the above-described extension of IEEE Standard 802.11e/D1 is not adequate to provide both qualitative (prioritized) and quantitative (parameterized) QoS service, and thus is not adequate to provide pleasant user experience with, for example, multimedia applications such as mentioned above. The eight additional priority values can be pre-mapped to denote the eight relative priorities of service as specified in IEEE Std 802.11D (incorporated herein by reference), but there is no provision for representing quantitative (customized) QoS services as demanded or desired by existing and future applications.

It is therefore desirable to provide for representation of quantitative QoS services in WLAN and WPAN applications.

The present invention extends the aforementioned limited QoS capability of the IEEE Std 802.11e/D1 to support full QoS, so that multimedia applications, either already or yet to be developed, are adequately served while efficient channel access is effected. The invention advantageously enables the primitive to signal both qualitative (prioritized) and quantitative (parameterized) QoS requirements to the MAC for handling the transfer of the MSDU contained in the primitive in a more fully QoS capable way.

### BRIEF DESCRIPTION OF THE DRAWINGS

FIG. 1 illustrates in tabular format the possible values of priority and service class parameters according to the prior art.

FIG. 2 illustrates in tabular format the possible values of priority and service class parameters according to exemplary embodiments of the invention.

FIG. 3 illustrates in tabular format the possible values of priority and service class parameters according to further exemplary embodiments of the invention.

FIG. 4 illustrates in tabular format the possible values of priority and service class parameters according to still further exemplary embodiments of the invention.

FIG. 5 diagrammatically illustrates pertinent portions of exemplary embodiments of a broadband communications station according to the invention.

FIG. 6 illustrates exemplary operations which can be performed by the broadband communications station of FIG. 5.

FIG. 7 diagrammatically illustrates the data link layer and physical layer portions of an exemplary broadband communications station according to the invention.

FIG. 8 diagrammatically illustrates a transmission model according to the invention, including pertinent portions of a broadband communications sending station and a broadband communications receiving station.

### DETAILED DESCRIPTION

In some exemplary embodiments, the present invention extends the range of priority parameter values to allow two values that are supported at all stations, Contention and ContentionFree, and sixteen additional values that are supported only at QoS capable stations, namely the integers between and including 0 and 7 for a direct representation of the relative QoS priorities requested for the transport of the MSDU, and the integers between and including 8 and 15 for an indirect representation of the parameterized QoS requirements (quantitative QoS requirements for, e.g., delivery delay, delay jitter, minimum and maximum data rate, and the like) requested for the transport of the MSDU. The parameterized QoS requirements may be defined (for example in a look-up table) by the MAC sublayer management entity (MLME) and station management entity (SME) prior to the arrival of any MSDUs for a given session requiring full QoS support.

In other exemplary embodiments, the present invention extends the range of service class parameter values to allow two values that are supported at all stations, ReorderableMulticast and StrictlyOrdered, and two additional values that are supported only at QoS capable stations, ReorderableMulticastParameterizedQoS (RMPQoS) and StrictlyOrderedParameterizedQoS (SOPQoS). If the value of the service class parameter is ReorderableMulticast or StrictlyOrdered, the values of the priority parameter in the range of 0 to 7 directly represent the relative QoS priorities requested for the transport of the MSDU. If the value of the service class parameter is ReorderableMulticastParameterizedQoS or StrictlyOrderedParameterizedQoS, the values of the priority parameter in the range of 0 to 7 indirectly represent the aforementioned parameterized QoS requirements requested for the transport of the MSDU. The parameterized QoS requirements may be defined (for example in a look-up table) by the MAC sublayer management entity (MLME) and station management entity (SME) prior to the arrival of any MSDUs for a given session requiring full QoS support.

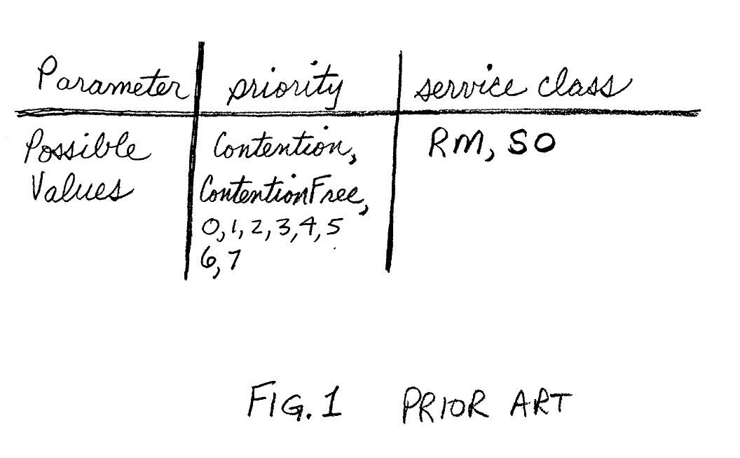

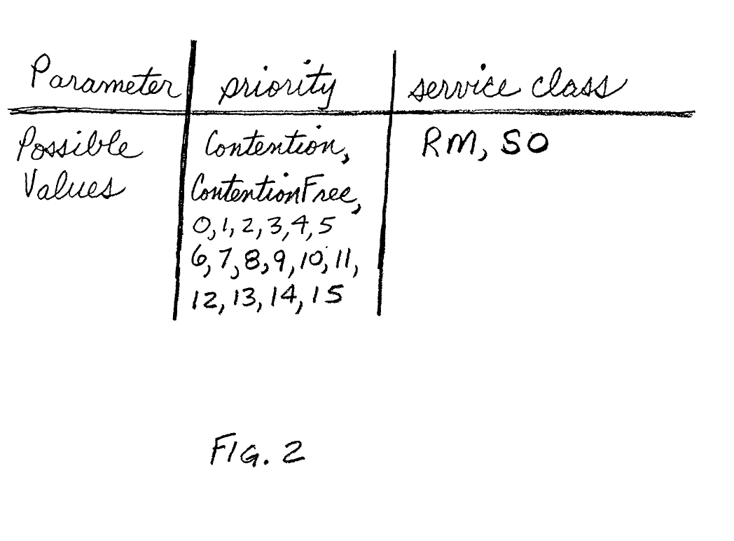

FIG. 2 illustrates in tabular format the possible values of the priority and service class parameters according to exemplary embodiments of the invention. The possible values of the priority parameter in FIG. 2 include all of those illustrated in FIG. 1, plus the integer values from 8 through 15, inclusive, for an indirect representation of the parameterized (quantitative) QoS requirements. The possible values of the service class parameter in FIG. 2 are the same as in FIG. 1.

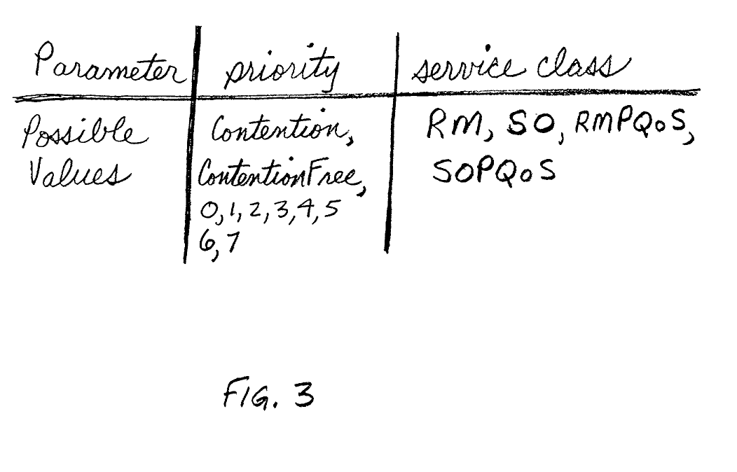

FIG. 3 illustrates in tabular format the possible values of the priority and service class parameters according to further exemplary embodiments of the invention. The possible values of the priority parameter in FIG. 3 are the same as in prior art FIG. 1. The possible values of the service class parameter in FIG. 3 include both of the values of the service class parameter shown in FIGS. 1 and 2, and also include RMPQoS and SOPQoS. In the embodiments illustrated by FIG. 3, if the service class parameter value is RM or SO, the priority parameter integer values 0 through 7, inclusive, directly represent the relative QoS priorities requested for transport of the MSDU. If the service class parameter value is RMPQoS or SOPQoS, then the priority parameter values 0 through 7, inclusive, indirectly represent the paramaterized (quantitative) QoS requirements requested for transport of the MSDU.

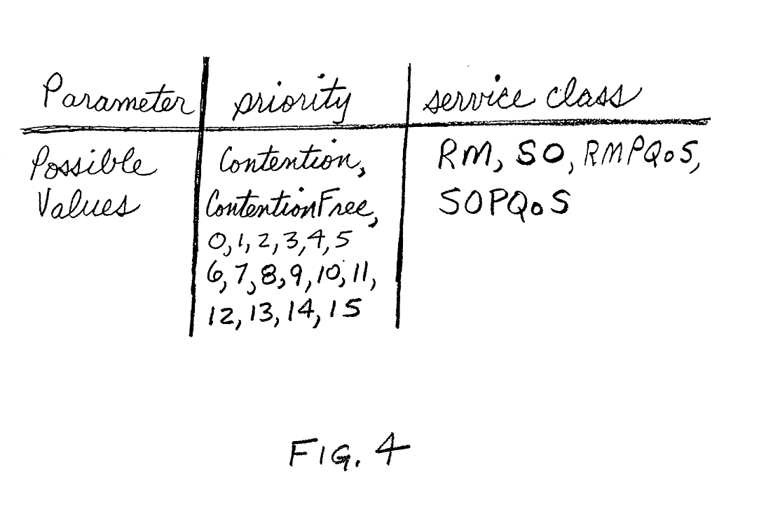

FIG. 4 illustrates in tabular format the possible values of the priority and service class parameters according to still further exemplary embodiments of the invention. In FIG. 4, the possible values of the priority parameter are the same as in FIG. 2, and the possible values of the service class parameter are the same as in FIG. 3. Thus, FIG. 4 illustrates embodiments in which the paramaterized (quantitative) QoS requirements can be represented indirectly by priority parameter values 8 through 15, inclusive, in the same manner as described above with respect to FIG. 2, or can be represented indirectly by the priority parameter values 0 through 7, inclusive, in the same manner as described above with respect to FIG. 3.

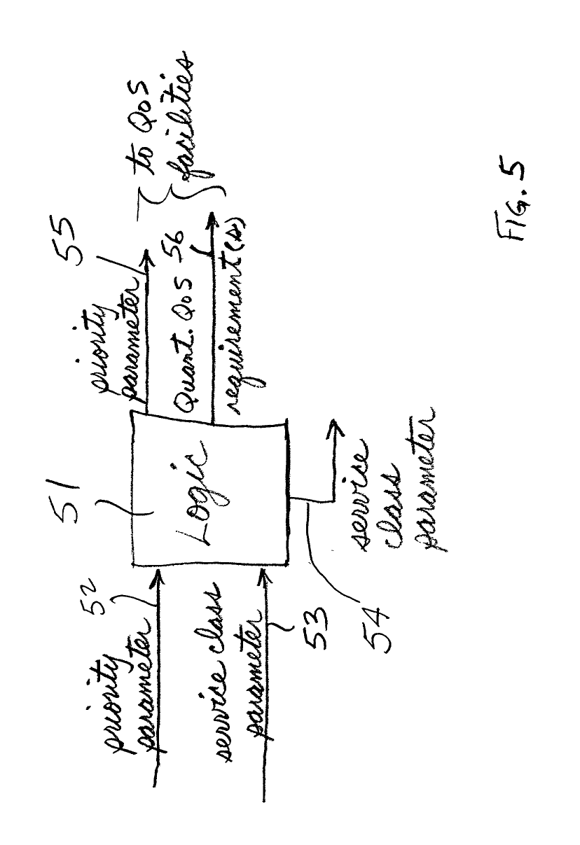

FIG. 5 diagrammatically illustrates pertinent portions of exemplary embodiments of a broadband communications station according to the invention. The broadband communications station of FIG. 5 includes logic 51 having an input 52 for receiving the priority parameter and an input 53 for receiving the service class parameter. In response to the priority parameter value received at 52 and the service class parameter value received at 53, the logic 51 produces a service class parameter output 54 for conventional use within the broadband communications station. Also in response to the parameter values received at 52 and 53, the logic 51 either passes the priority parameter value 52 directly to the QoS facilities of the broadband communications station at 55, or determines the desired parameterized (quantitative) QoS requirement(s) and outputs such requirement(s) at 56 for use by the QoS facilities.

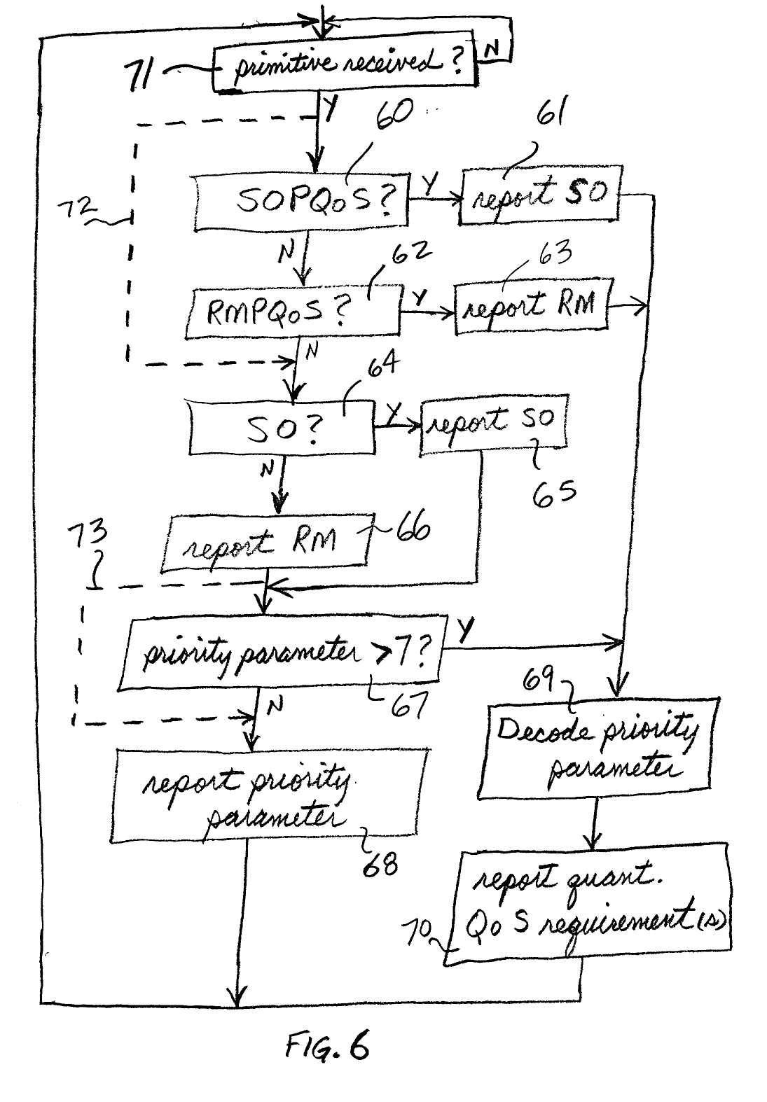

FIG. 6 illustrates exemplary operations which can be performed by the logic 51 of FIG. 5. It is determined at 60 whether or not the service class parameter value of a received primitive is SOPQoS. If so, then the service class parameter value SO is reported at 61 (see output 54 in FIG. 5), and the priority parameter value is decoded at 69, for example by applying the priority parameter value to a look-up table within logic 51 of FIG. 5. At 70, the result of the decoding operation at 69 (for example the output of the look-up table) is reported as the quantitative QoS requirement(s) (see 56 in FIG. 5). The next primitive is then awaited at 71.

If the service class parameter value is not SOPQoS at 60, it is then determined at 62 whether the service class parameter value is RMPQoS. If so, then the service class parameter value RM is reported at 63, after which operations proceed to 69-71 as described above. If the service class parameter value is not RMPQoS at 62, it is then determined at 64 whether the service class parameter value is SO. If so, then the service class parameter value SO is reported at 65, after which it is determined at 67 whether the priority parameter value is greater than 7. If so, then the aforementioned operations at 69-71 are performed as described above. If the priority parameter value is not greater than 7 at 67, then the priority parameter value is reported at 68 (see 55 in FIG. 5), after which the next primitive is awaited at 71.

If the service class parameter value is not SO at 64, then the service class parameter value RM is reported at 66. Thereafter, if the priority parameter value is greater than 7 at 67, then the operations at 69-71 are performed as described above. Otherwise, the priority parameter value is reported at 68 as described above. Thereafter, the next primitive is awaited at 71.

Broken line 72 of FIG. 6 illustrates operations of embodiments corresponding to FIG. 2, and broken line 73 of FIG. 6 illustrates operations of embodiments corresponding to FIG. 3. The complete diagram of FIG. 6, without the broken line paths 72 and 73, illustrates operations of embodiments corresponding to FIG. 4.

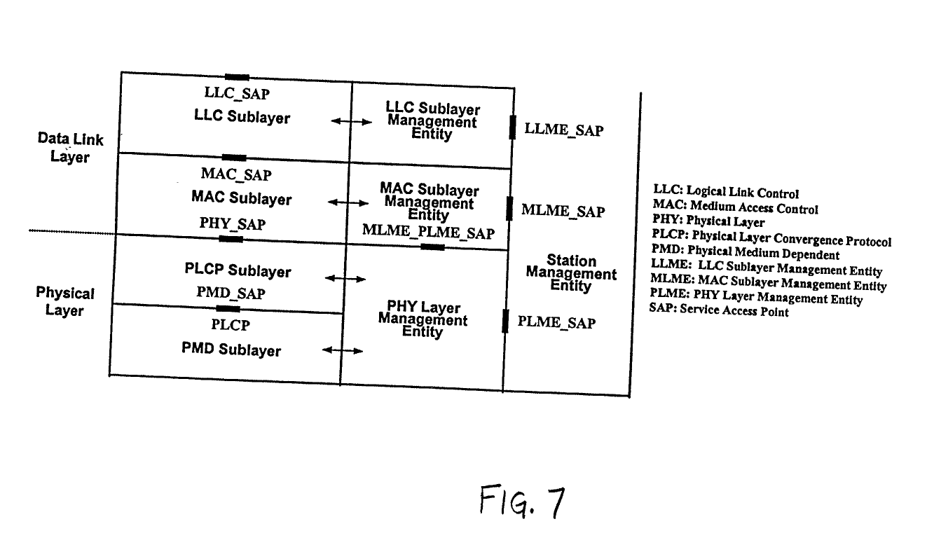

FIG. 7 diagrammatically illustrates the data link layer and physical layer portions of an exemplary broadband communications station (e.g., an IEEE Std 802.11station) in which the present invention can be implemented. In particular, the priority and service class parameters illustrated in FIGS. 2-4 are passed from the LLC sublayer to the MAC sublayer in an extended version of the aforementioned MAUNITDATA.request primitive described above. This extended primitive is passed from the LLC sublayer to the MAC sublayer through the MAC service access point, MAC_SAP. The above-described operations of logic 51 (see FIGS. 5 and 6) are performed logically by the MAC sublayer and at least one of the MAC sublayer management entity (MSME) and the station management entity (SME).

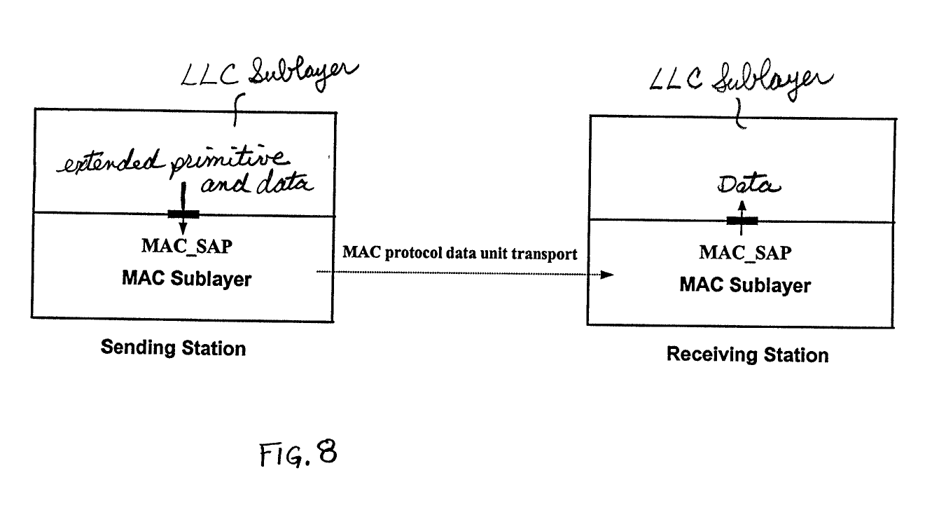

FIG. 8 diagrammatically illustrates pertinent portions of a broadband communications sending station and a broadband communications receiving station according to the invention. As shown in FIG. 8, an extended primitive including selected ones of the possible priority and service class parameter values of one of FIGS. 2-4 is passed from the LLC sublayer of the sending station to the MAC sublayer of the sending station, along with associated data (i.e., an MSDU). The MAC sublayer of the sending station is responsive to the extended primitive for signaling to the QoS facilities of the sending station the QoS transport specified by the service class parameter value and/or the priority parameter value of the extended primitive. The selected QoS transport can be qualitative, for example, when the service class parameter value is either RM or SO and the priority parameter value is one of the eight values from 0 through 7, inclusive. The selected QoS transport can also be quantitative (parameterized), for example, if the priority parameter value is one of the eight values between 8 and 15, inclusive, or if the service class parameter value is either RMPQoS or SOPQoS. The data transmission from the sending station to the receiving station is effectuated in accordance with the QoS specified by the extended primitive. This data transport is conceptually illustrated between respective peer MAC sublayers in the sending and receiving stations. The MAC sublayer of the receiving station passes the transported data (MSDU) through the MAC_SAP of the receiving station to the LLC sublayer of the receiving station.

Although exemplary embodiments of the invention are described above in detail, this does not limit the scope of the invention, which can be practiced in a variety of embodiments.

What is claimed is:

1. A method of indicating a QoS requirement in a broadband communications station, comprising:
providing a parameter having a first possible value which indicates that a qualitative QoS requirement is to be implemented for a transport of associated data traffic and having a second possible value which indicates that a quantitative QoS requirement is to be implemented for said transport of said data traffic;
passing the parameter from a first sublayer of a data link layer implemented in the broadband communications station to a second sublayer of the data link layer; and
passing said data traffic from the first sublayer to the second sublayer.

2. The method of claim 1, wherein said parameter is an IEEE 802.11 service primitive parameter, said parameter passing step including passing the parameter from an LLC sublayer to a MAC sublayer.

3. The method of claim 2, wherein the parameter is a priority parameter.

4. The method of claim 2, wherein the parameter is a service class parameter.

5. The method of claim 4, wherein the second possible value of the service class parameter is indicative of a service class to be implemented for said transport of said data traffic.

6. The method of claim 1, wherein said quantitative QoS requirement includes one of delivery delay, delay jitter, minimum data rate and maximum data rate.

7. The method of claim 1, wherein said parameter passing step includes passing a further parameter from the first sublayer to the second sublayer.

8. The method of claim 7, including, in response to said first mentioned parameter having said second possible value, decoding said further parameter to determine the quantitative QoS requirement that is to be implemented.

9. The method of claim 8, wherein both of said parameters are IEEE 802.11 service primitive parameters.

10. The method of claim 9, wherein said first-mentioned parameter is a service class parameter and said further parameter is a priority parameter.

11. The method of claim 10, wherein said second possible value of said service class parameter also indicates a service class requirement to be implemented for said transport of said data traffic.

12. The method of claim 8, wherein said further parameter has a plurality of possible values corresponding respectively to a plurality of available quantitative QoS requirements.

13. The method of claim 1, wherein said first possible value of said parameter specifies said qualitative QoS requirement and said second possible value of said parameter specifies said quantitative QoS requirement, and including selecting implementation of said qualitative QoS requirement if said parameter has said first possible value, and selecting implementation of said quantitative QoS requirement if said parameter has said second possible value.

14. The method of claim 1, wherein said providing step includes providing a parameter having a first plurality of first possible values respectively indicative of a plurality of available qualitative QoS requirements and having a second plurality of second possible values respectively indicative of a plurality of available quantitative QoS requirements.

15. The method of claim 14, including determining from said parameter which of said plurality of available qualitative QoS requirements and said plurality of available quantitative QoS requirements is to be implemented.

16. A broadband communications station, comprising:
a data link layer portion including first and second sublayers;
a service access point provided between said sublayers for passing information from first said sublayer to said second sublayer;
said service access point operable for passing from said first sublayer to said second sublayer a parameter having a first possible value which indicates that a qualitative QoS requirement is to be implemented for a transport of associated data traffic and having a second possible value which indicates that a quantitative QoS requirement is to be implemented for said transport of said data traffic; and
said service access point further operable for passing said data traffic from said first sublayer to said second sublayer.

17. The broadband communications station of claim 16, including logic coupled to said service access point for determining from said parameter whether said qualitative QoS requirement or said quantitative QoS requirement is to be implemented, and including QoS facilities coupled to said logic for receiving therefrom information indicative of which of said QoS requirements is to be implemented.

18. The broadband communications station of claim 16, wherein said first possible value of said parameter specifies said qualitative QoS requirement and said second possible value of said parameter specifies said quantitative QoS requirement, and including logic coupled to said service access point for selecting implementation of said qualitative QoS requirement if said parameter has said first possible value, and selecting implementation of said quantitative QoS requirement if said parameter has said second possible value.

19. The broadband communications station of claim 16, wherein said service access point is further operable for passing a further parameter from said first sublayer to said second sublayer, and including logic coupled to said service access point and responsive to said first mentioned parameter having said second possible value for decoding said further parameter to determine the quantitative QoS requirement that is to be implemented.

20. The broadband communications station of claim 19, wherein both of said parameters are IEEE 802.11 service primitive parameters.

21. The broadband communications station of claim 20, wherein said first-mentioned parameter is a service class parameter and said further parameter is a priority parameter.

22. The broadband communications station of claim 21, wherein said logic is operable for detecting from said second possible value of said service class parameter a service class requirement to be implemented for said transport of said data traffic.

23. The broadband communications station of claim 16, wherein said parameter has a first plurality of first possible values respectively indicative of a plurality of available qualitative QoS requirements and has a second plurality of second possible values respectively indicative of a plurality of available quantitative QoS requirements, and including logic coupled to said service access point and responsive to said parameter for determining a desired QoS requirement represented by said parameter.

24. The broadband communications station of claim 16, operable in one of a WLAN and a WPAN.
